(19) United States
(12) Patent Application Publication
(10) Pub. No.: US 2024/0135085 A1
(43) Pub. Date: Apr. 25, 2024

(54) Managing Display Resources

(71) Applicant: 1Bstories Pte. Ltd., Singapore (SG)

(72) Inventors: Ravi Hamsa, Bangalore (IN); Anuvrat Rao, Singapore (SG)

(21) Appl. No.: 18/071,900

(22) Filed: Nov. 30, 2022

(30) Foreign Application Priority Data
Oct. 17, 2022 (IN) 202211059202

(51) Int. Cl. G06F 40/106; G06F 40/109; G06F 40/143; G06F 40/189

(52) U.S. Cl. CPC G06F 40/106; G06F 40/109; G06F 40/143; G06F 40/189

(57) ABSTRACT

Systems and methods are provided for re-formatting text content of web content that is defined according to a ‘listicle’ format. A web resource comprising a display boundary frame and text content is received at a browser, where the text is of a predefined font size. A re-formatting engine re-scales the frame to generate a modified frame, where the modified frame has the same measurements as a display window for the web content. The web content is displayed in the modified frame in the display window, the text content having a modified font size.

### FIELD

This application relates to a computer-implemented method and system for re-formatting content of a display device.

### BACKGROUND

A vast array of information is available almost instantly via the internet. The list of devices capable of accessing online content also ever-expanding, with internet access being commonplace in devices such as desktop computers, laptops, mobile phones, tablet computers, televisions, games consoles, smart appliances, and other smart systems. Online content may also be presented in in one of an enormous selection of different formats, including by way of example: videos, online marketplaces, blog posts, forum threads, messaging services, and the like. There are many challenges in providing the same online content on different display devices—of varying dimensions, aspect ratios, and resolutions—in a way that provide consistent use of screen resource and comparable user experience. The present disclosure relates to systems and methods for managing display resources of electronic devices, enabling consistent user experience of an online content resource on electronic displays of varying dimensions and resolutions.

An aspect ratio, as referred to herein, may be understood as a ratio between a horizontal size of a display device or window, and a vertical size of a display device or window.

Whilst online content may be provided according to any number of modalities or format templates, most online content is defined, formatted, accessed, and displayed according to the same fundamental conventions, as described below.

Online content is generally hosted, or stored, as a resource in a memory component of a server computer, which is connected to the internet. Users may use an internet-enabled client device, such as those identified above, to locate online content they want to view and retrieve it from the server.

A markup language, such as ‘Hypertext Markup Language’ (HTML), may be used to define structural aspects of an online resource, or website, for example tagging aspects of the online content that should be considered headings, subheadings, or body text etc.

Visual aspects of an online resource, such as colour, positioning, animation, and other aesthetic features may be determined by code that defines a Cascading Style Sheet, or CSS. Visual attributes in CSS code may be defined in respect of the structural features defined in the associated HTML code. That is, particular aesthetic features may be defined in respect of titles and subtitles, and a different set of aesthetic attributes may be defined in respect of standard body text, e.g., in paragraphs. CSS code may be embedded in HTML code. Alternatively, a path to a distinct memory location comprising CSS code defining visual aspects of the resource may be provided in the CSS code, thereby establishing a link between structural and visual aspects of the resource.

Functional components of web resources may also be defined by computer code. For example, JavaScript is a ubiquitous and very powerful coding language used to implement functional features in online content. As with CSS, JavaScript or other functional programming may be embedded within a corresponding HTML file, or may be stored in a different memory location, with the HTML file providing a link to the JavaScript that identifies a path to the different memory location.

An online resource stored at a server or other host system may be accessed by an internet-enabled client device via a browser. A browser is a computer program that is local to the client device, which is configured to receive input identifying a resource, send an access request to a host system that holds the resource, receive a message comprising the resource, and to render and display the resource at a display device of the client device.

The input identifying the resource may be in the form of input of a Uniform Resource Locator, or ‘URL’, which defines a domain to be accessed, and path within that domain to a memory location comprising the resource to be accessed.

The access request may be made via the internet, or via a local intranet.

The message sent back to the browser by a server of the accessed domain may comprise HTML, CSS, and JavaScript code that respectively define the structural, visual, and functional behaviour of the accessed resource. The browser may be configured, upon receipt of the resource, to construct, render, and display the resource at the client device according to the structure, aesthetics and functionalities defined in the received resource.

### Summary

The present description relates, in particular but not exclusively, to display of online content in a format known as a ‘web story’. A web story, also referred to herein as a ‘multi-screen user engagement experience’, or MUEE, for short, may be considered a distinct web-publishing format. MUEEs are an engaging, fast-paced and aesthetically pleasing medium for conveying information online in a variety of contexts, such as news, entertainment, sport, advertisement, social media etc. A MUEE may comprise one or more page, wherein each page may occupy a predefined region of a display and may not be scrollable. That is, all content that is provided on a page of a MUEE may be displayed within the predefined region, and there may be no option to scroll down the page to reveal further content.

A browser, which accesses and causes the MUEE to be rendered, may therefore be capable of identifying a display region size or window size, which the MUEE or other online content is to occupy on the display of the client device. The window size may be defined by an absolute number of pixels in a horizontal and vertical direction on the display, or by a percentage of the dimensions of the entire display device, in which case a number of horizontal and vertical pixels within the window region is further dependent on pixel density or resolution of the display device. Since window sizes may vary, and display devices of different sizes and resolutions may be used to display online content, a browser program may be capable of re-rendering online content to fit a current amount of available display space. It is with respect to this local re-formatting of online content that the present disclosure is made.

The present invention solves a problem of improving display-space management on an electronic display device for rendering MUEE content, in particular text-based content. That is, regardless of display or window dimensions within which to render a page of a MUEE, and regardless of display dimensions for which the MUEE is intended (original base dimensions), the presently described systems and methods are capable of providing a consistent and congruent layout of textual content on the display space, thereby universally improving the use of display resources when rendering online content such as MUEEs, and reducing the requirement for content providers to configure content for each platform.

According to a first aspect of the present invention there is provided a computer device configured to re-format text content of a non-scrollable multi-screen web resource, the computer device comprising:
a browser configured to receive a message indicating the web resource, the web resource comprising:
   a frame defining a display boundary and having first measurements in two dimensions; and
   text content of a predefined font size;
a display comprising a display window, wherein the display window has second measurements in the two dimensions; and
a re-formatting engine configured to:
   determine a first ratio indicating the size of the second measurements of the display window in a first dimension of the two dimensions, relative to the first measurements of the frame in the first dimension;
   determine a second ratio indicating the size of the second measurements of the display window in a second dimension of the two dimensions, relative to the first measurement of the frame in the second dimension;
   re-scale the frame to generate a modified frame, the modified frame having the same second measurements as the display window;
   perform a comparison operation to determine a smallest ratio of the first and second ratios, and re-scale the predefined font size by a factor of the smallest ratio to determine a modified font size; and
   cause display, within the display window of the display, of the modified frame of the web resource comprising text content of the modified font size.

In some embodiments, the frame further comprises a text region of a predefined size within the frame, the text region supporting the text content, and wherein the re-formatting engine is further configured to:
re-scale the text region in the first and second dimensions by respective scaling factors equal to the first and second ratios, to generate a modified text region; and cause display of the text content of the modified font size within the modified text region.

In some embodiments, the display occupies an entire display region of the display.

In some embodiments, the display window occupies a subset of a display region of the display.

In some embodiments, the display comprises a plurality of display windows and wherein the modified frame and text content of the modified font size are displayed in one of the plurality of display windows.

In some embodiments, the computer device comprises a computer memory in which the second measurements of the display window are stored as metadata, wherein the second measurements in the computer memory are accessible to the re-formatting engine for determining the first and second ratios.

In some embodiments, the re-formatting engine is comprised within the browser.

In some embodiments, the text region has a predefined position within the frame and wherein the re-formatting engine is further configured to:
identify a reference point associated with the text region;
calculate a relative position of the reference point in the first and second dimensions, relative to the first measurements of the frame;
determine an absolute position of the reference point within the modified frame, at which the relative position of the reference point relative to the second measurements of the modified frame is the same as the relative position of the reference point relative to the first measurements of the frame; and
cause display of the modified text region such that the reference point associated with the modified text region is located at the determined absolute position.

In some embodiments, the reference point is identified at a centre of the associated text region.

In some embodiments, the reference point is identified at a corner of the associated text region.

In some embodiments, a horizontal alignment of the text content of the web resource within the text region is defined as one of: left-aligned, right-aligned, centre aligned, or justified, and wherein a vertical alignment of the text content of the web resource within the text region is defined as one of: top-aligned, middle-aligned, or bottom-aligned.

In some embodiments, the web resource is of a multi-screen user engagement experience format.

According to another aspect of the invention there is provided a non-transitory computer-readable media storing computer-executable instructions which, when executed by a processor, cause the processor to:
receive, at a browser of a computer device, a message indicating a web resource, the web resource comprising:
   a frame defining a display boundary and having first measurements in two dimensions; and
   text content of a predefined font size;
in the two dimensions, identify second measurements of a display window of the computer device;
determine a first ratio indicating the size of the second measurements of the display window in a first dimension of the two dimensions, relative to the first measurements of the frame in the first dimension;
determine a second ratio indicating the size of the second measurements of the display window in a second dimension of the two dimensions, relative to the first measurement of the frame in the second dimension;
re-scale the frame to generate a modified frame, the modified frame having the same second measurements as the display window;
perform a comparison operation to determine a smallest ratio of the first and second ratios, and re-scale the predefined font size by a factor of the smallest ratio to determine a modified font size; and
cause display, within the display window of the display, of the modified frame of the web resource comprising text content of the modified font size.

According to yet another aspect of the invention there is provided a computer implemented method of re-formatting text content of a non-scrollable multi-screen web resource, the method comprising:
receiving, at a browser of a computer device, a message indicating a web resource, the web resource comprising:
   a frame defining a display boundary and having first measurements in two dimensions; and
   text content of a predefined font size;
in the two dimensions, identifying second measurements of a display window of the computer device;
determining a first ratio indicating the size of the second measurements of the display window in a first dimension of the two dimensions, relative to the first measurements of the frame in the first dimension;
determining a second ratio indicating the size of the second measurements of the display window in a second dimension of the two dimensions, relative to the first measurement of the frame in the second dimension;
re-scaling the frame to generate a modified frame, the modified frame having the same second measurements as the display window;
performing a comparison operation to determine a smallest ratio of the first and second ratios, and re-scaling the predefined font size by a factor of the smallest ratio to determine a modified font size; and
causing display, within the display window of the display, of the modified frame of the web resource comprising text content of the modified font size.

### BRIEF DESCRIPTION OF THE DRAWINGS

For a better understanding of the present invention and to show how the same may be carried into effect, reference will now be made by way of example to the accompanying drawings in which:

FIG. 1 shows three pages of an exemplary online resource provided in a “MUEE” format.

FIG. 2 shows a highly schematic diagram that illustrates a computing environment in which a client device requests access to an online resource via a network.

FIG. 3 shows a highly schematic diagram that illustrates an example in which a known re-formatting technique is implemented.

FIG. 4 shows a highly schematic diagram that illustrates an example in which the present re-formatting technique is implemented.

FIG. 5 shows a highly schematic diagram in which three client devices of differing display dimensions request access to a same online resource via a network.

FIG. 6 shows a highly schematic diagram that illustrates components and functionalities of a client device according to the present invention.

In the drawings, corresponding reference characters indicate corresponding components. The skilled person will appreciate that elements in the Figures are illustrated for simplicity and clarity and have not necessarily been drawn to scale. For example, the dimensions of some of the elements in the Figures may be exaggerated relative to other elements to help improve understanding of various example embodiments.

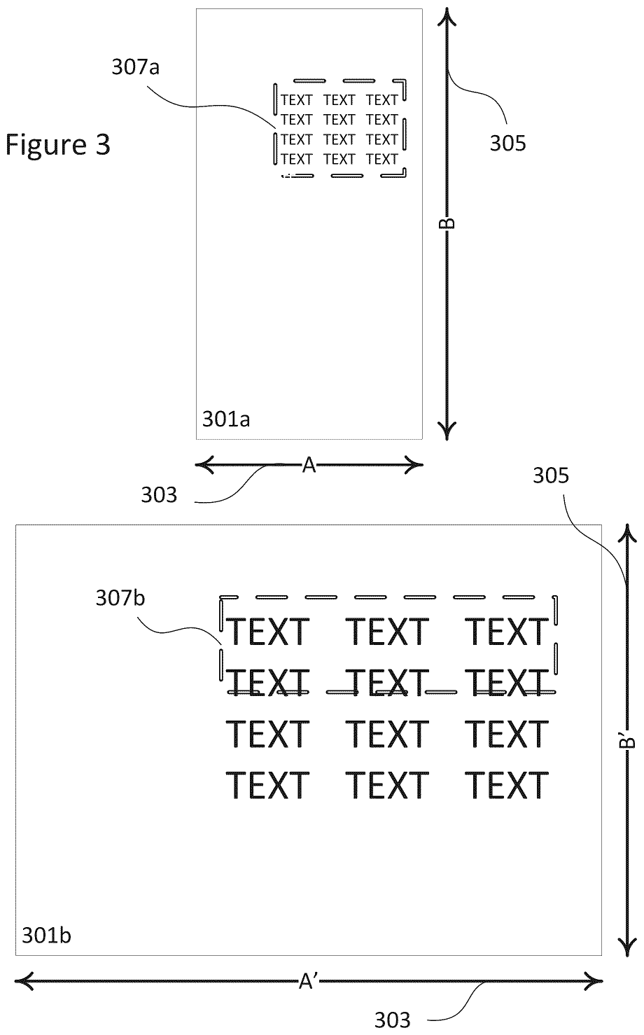

It should be noted, however, that certain aspects of FIGS. 3-5 are drawn to scale locally, such that certain relative lengths are consistent within the drawing.

Also, common but well understood elements that are useful and necessary in a commercially feasible embodiment are often not depicted in the drawings, in order to facilitate a less obstructive view of these various example embodiments.

It will also be appreciated that where reference numerals of the form xxx-a, xxx-b etc., are used to denote a particular instance of a feature of the drawing, the same reference numeral without a specified letter may denote a generic instance of the same feature.

### DETAILED DESCRIPTION

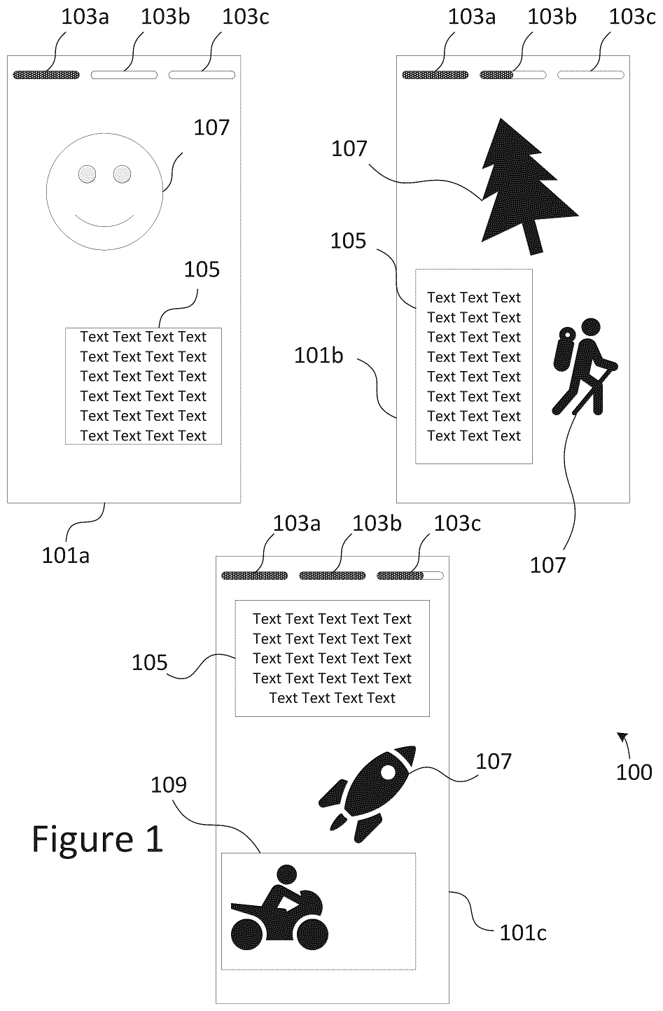

By way of background, reference is made to FIG. 1, which shows a highly schematic diagram illustrating three pages 101a, 101b, 101c of an exemplary web story 100, or MUEE, which may be rendered on a display of a client device. Provided on each page 101 of the exemplary MUEE 100 is a quantity of page indicators 103, wherein the quantity of page indicators 103 corresponds one-to-one with the quantity of pages provided in the MUEE 100. That is, a particular page indicator, e.g., 103a, 103b, 103c, represents a particular respective page 101a, 101b, 101c within the MUEE 100. The order in which the page indicators 103a, 103b, 103c are arranged from left to right on the page 101 may correspond to the order in which the pages are rendered in a sequence. A client device may render the first page 101a upon accessing the MUEE 100, and may then render the second page 101b upon receipt of a qualifying user input, or upon lapse of a predetermined time period.

When a particular page 101 of the MUEE is viewed by a user—that is, when the display device renders a particular one of the quantity of pages, e.g., 101a—a visual effect may be applied to a corresponding page indicator 103a such that the user may visually determine which page 101 within the MUEE 100 is presently rendered on the display device. In an embodiment in which a next page 101b of the MUEE is rendered when a predetermined amount of time has passed whilst viewing the first page 101a, the visual effect of the first page indicator 103a may extend or grow from a left-hand side of the indicator 103a as the predetermined time elapses until the predetermined time period has passed, at which point the visual indicator fills the entire page indicator 103a.

For example, on page 101b of the MUEE 100 in FIG. 1, a left-half of the page indicator 103b comprises a visual effect, indicating that the user is viewing page 101b and has been viewing it for half of a predetermined period of time. In some embodiments, such as that shown in FIG. 1, page indicators representing pages 101 which precede a presently viewed page 101 may retain the visual effect when they have been viewed and a next page 101 is rendered.

FIG. 1 further demonstrates the types of content that may be provided on a page 101 of a MUEE 100. For example, the first, second and third pages, 101a, 101b, and 101c respectively, all comprise a text region 105, which may comprise text of any font, size, weight or other text attribute. Each page 101 further comprises one or more image 107. Page 101c further shows an exemplary video 109 which is embedded into that page 101c of the MUEE 100, and which may play automatically upon rendering the third page 101c.

It will be appreciated that, generally, a page 101 of a MUEE may comprise any number of text regions, images, videos, or content in any other media format. The pages 101a-101c of FIG. 1 are provided by way of example only.

Since all content of a page in a MUEE must fit into a provided display region, it is especially critical that display device space-management techniques can adapt to different display dimensions, because MUEE content on a page may not be movable off screen and accessed by scrolling. Further, it is becoming increasingly important to cater for a wider range of aspect ratios because more and more types of devices in wide ranges of aspect ratios are now able to access and render MUEE content.

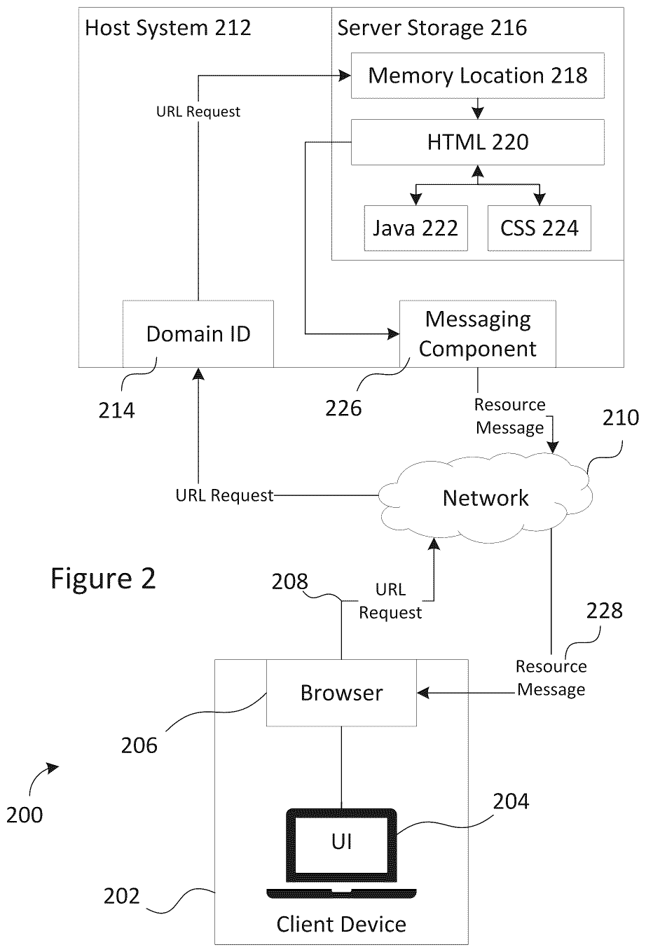

Reference is also made to FIG. 2, which shows a highly schematic diagram that illustrates an exemplary process of requesting and accessing online content for display at a client device.

### Accessing Content via a Network

FIG. 2 shows an exemplary virtual environment 200 that shows how a client device 202 may request access to an online resource for rendering at a user interface (UI) 204 of the client device 202, wherein the UI 204 comprises an electronic display device.

The client device 202 further comprises a browser 206, which may be considered any suitable computer program that is local to the client device and is configured to receive an input indicating a resource access request, locate and request access to the indicated resource, receive an electronic message indicating the resource, and compile the accessed resource for display at the UI 204 of the client device 202.

The browser may, for example, be configured to receive input in a URL format which, as described above, may identify a computer storage location at which one or more content item is to be accessed. That is, the URL may be a string input that defines a domain and a path within that domain. The domain may identify a server or host device at which the content item is stored, and the path may indicate a location within a storage component from which data is to be accessed.

The browser 206 may be configured, upon input of a URL, connect to a network 210 to which a plurality of computing devices has remote access. In some examples, the network 210 may be a local network. In other examples, the network 210 may be the internet. Based on the input URL, the browser 206 may transmit an access request 208 across the network 210, identifying a server or, more generally, a host system 212 that is also connected to the network 210, wherein the host system 212 is specified by the domain within the input URL.

That is, each computer device in the network 210, e.g., client device 202 and server 212, may be associated with a domain ID 214. An access request 208 sent by a browser 206 may be directed to a server with a particular domain ID 214 when that particular domain ID is specified in a URL input to the browser 206. It will be appreciated that the access request may be an HTTP (Hyper-Text Transfer Protocol) request that is directed to a host system 212 associated with an IP address specified within the request 208. That is, a URL may indicate an IP address of the host system 212. Those skilled in the art will also appreciate that an encrypted HTTPS request may also be utilised.

The host system 212 may comprise a storage component 216, storing online resources for access by a client device 202. For example, the storage component 216 may comprise web content in the form of, for example, HTML, CSS, and JavaScript code.

It will be appreciated that in some embodiments, a domain may be constituted by a plurality of distinct server components. In such embodiments, a URL may specify the domain 214 and a particular server therein from which data is to be retrieved. In practice, a URL may comprise as many path components as is necessary to navigate and locate data within a host system 212.

When an access request 208 by a browser 206 reaches a host system 212, the host system 212 may access a memory location 218 specified by the access request 208, e.g., based on the path indicated in the URL input to the browser 206.

The specified memory location 218 may comprise one or more HTML file 220, defining the structure and content of an online content item to which access has been requested by the browser 206. The HTML file 220 may be linked to one or more separate data item comprising one or more of JavaScript code 222 and CSS code 224, respectively configured to define functional and visual aspects of the content item defined in the HTML code 220. It will be appreciated, as described above, that alternatively the HTML data 220 may comprise integral JavaScript 222 and CSS 224 code.

Upon accessing the specified content 220-224 from the memory location 218, the host system 212 may utilise a messaging component 226 to transmit a resource message 228 across the network 210 to the browser 206 which requested access to the content item. It will be appreciated that the resource message 228 may also be an HTTP or HTTPS message indicating an IP address of the client device 202 and comprising, for example, a status code indicating success or failure of the request 208, a response header providing information about the host system 212, and a body component which may comprise the requested data in the form of the accessed HTML code 220 (optionally including JavaScript 222 and CSS 224).

Upon receipt of the resource message 228, the browser may be configured to read the HTML code 220, JavaScript 222 and CSS 224 to thereby construct the received data item according to its defined structure, functionalities, and visuals and render the content on the UI 204. The browser 206 may further access metadata associated with a display device of the UI 204 to determine technical attributes of the display device. That is, the browser 206 may be configured to identify absolute dimensions, pixel densities, and aspect ratios of display devices for use in rendering received content within the bounds of the display device.

The above is provided by way of example and is merely intended to represent a generic, highly schematic and simplified computing environment in which access to a content item such as a website or MUEE, for example, may be requested by a browser 206 for rendering at the UI 204 of a client device 202.

Numerous display devices of different physical and technical nature, i.e., of varying display dimensions, resolutions and/or pixel densities may be provided within a client device. These display devices of various dimensions may be capable of accessing MUEE content, so a browser or other program configured to access and render such content at the client device must be able to account for physical differences in display devices, if a consistent content layout is to be maintained and consistent use of display resource is to be provided.

### Known Text Re-Formattinq Techniques

Some tools for providing a textual re-formatting functionality are known. However, the known methods still encounter inconsistencies and irregularities in formatting across different devices, causing a different user experience on devices of different physical form, as discussed in more detail below.

According to a known re-formatting technique, a base layout of the content may be defined with first base dimensions. For text in the content, a font size that is suited to the base dimensions may be defined, for example in CSS code. When the content is rendered in a window or display region having second dimensions different to the base dimensions, a new font size may be calculated based on a fractional change in horizontal display space. That is, if a base font size is 36 pixels high and the second horizontal display dimension is double the base horizontal dimension, the new font size may correspondingly be rendered at double the original font size, in this case, 72 pixels. However, this approach is not consistent in situations where the second dimensions have a different aspect ratio compared to that of the base dimensions.

Text begins a new line upon reaching a right-hand extreme of the container. Therefore, if a container expands horizontally by a factor of x, and the font height and width correspondingly increase by a factor of x, the new line will begin at the same place within a sentence of the text. However, since the height of the text will also increase, vertical space occupied by the text will also increase by a factor of x. If the second vertical dimension does not increase by the same factor x, i.e., if the aspect ratio is altered, the text may overflow the container.

Reference is made to FIG. 3, which illustrates a problem inherent to the above-described, percentage-based, method of re-formatting. FIG. 3 shows a first, non-scrollable display page 301a that has first dimensions defining a first aspect ratio. The first page 301a may represent a page of a MUEE. The first page 301a has a horizontal dimension 303 of size A and a vertical dimension 305 of size B. The first page 301a comprises a text region 307a comprising body text of the page 301a.

FIG. 3 further shows a second non-scrollable display page 301b that has second dimensions defining a second aspect ratio. The second page 301b represents the same content of the same MUEE as in page 301a, but which is rendered on a display device or window that has different dimensions, and which has been re-formatted according to the known percentage-based technique described above. The second page 301b has a horizontal dimension 303 of size A′ and a vertical dimension 305 of size B′. The second page 301b comprises a text region 307b, which corresponds to text region 307a of the first page 301a.

Sizes of the re-sized text region 307b in each dimension 303, 305 may be proportional to the change in display screen or window dimensions. By way of example, in FIG. 3, the ratio

$$\frac{{A}^{′}}{A} = 2.594$$

and the ratio

$$\frac{{B}^{′}}{B} = 1.$$

The horizontal and vertical sizes of the second text region 307b on page 301b may be determined by multiplying the horizontal and vertical sizes of text regions 307a by factors of 2.594 and 1 respectively. Therefore, the fractional width and height of the text region 307b is the same as text region 307a of page 301a.

According to the techniques represented by FIG. 3, a browser configured to render the page 301b in the second dimensions (A′ , B′) may recognise that text within the text region 307b may be increased in size by a factor of 2.594 relative to the text in region 307a because the width of the region is also increased by a factor of 2.594. According to this re-formatting technique, line breaks in text, i.e., points within a portion of text at which a new line starts may be maintained across any display or window dimension because the width of text characters (i.e., font size) is adjusted proportionally to the size of the text region. However, changing a font size causes both vertical and horizontal increases in size of the text. Therefore, where aspect ratios vary between display devices, i.e., when the vertical dimension changes independently of the horizontal dimension

$$( \frac{{A}^{′}}{A} \neq \frac{{B}^{′}}{B} ) ,$$

relative consistency in formatting may not be maintained because text may overflow the text region in some examples, as can be seen in page 301b of FIG. 3.

The present invention addresses the above difficulties in providing a consistent re-formatting functionality across devices of varying dimensions and aspect ratios. The present invention makes use of novel data management techniques to ensure display devices of all dimensions, aspect ratios and resolutions are able to render a MUEE with a consistent textual layout and congruent user experience.

### Novel Display Resource Management Techniques

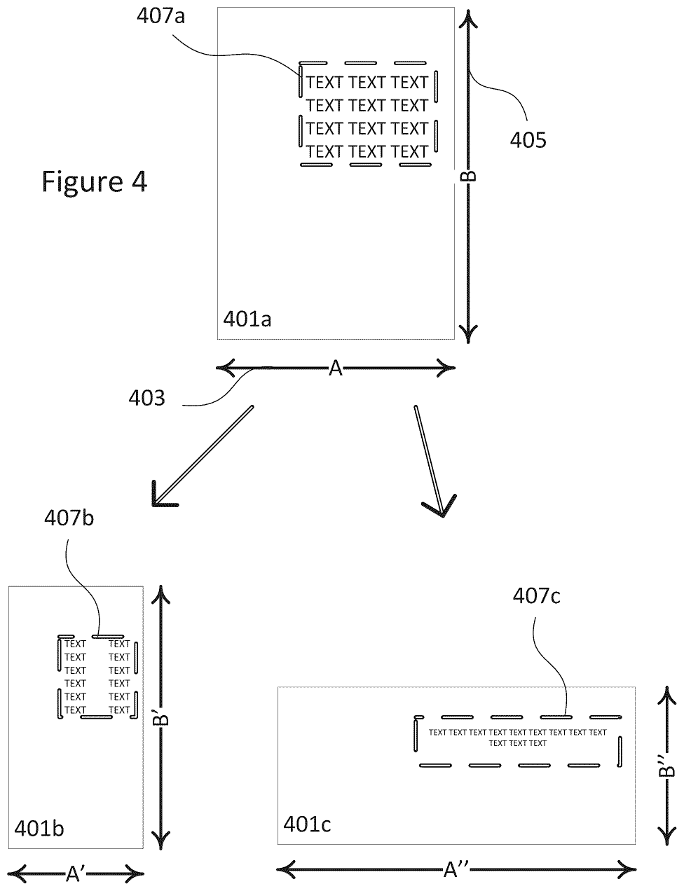

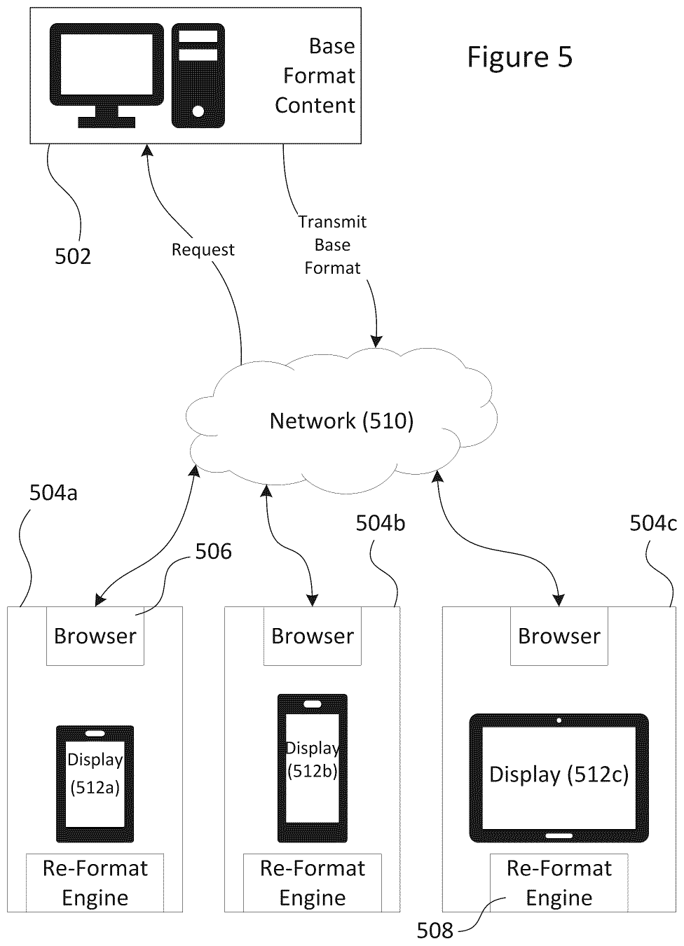

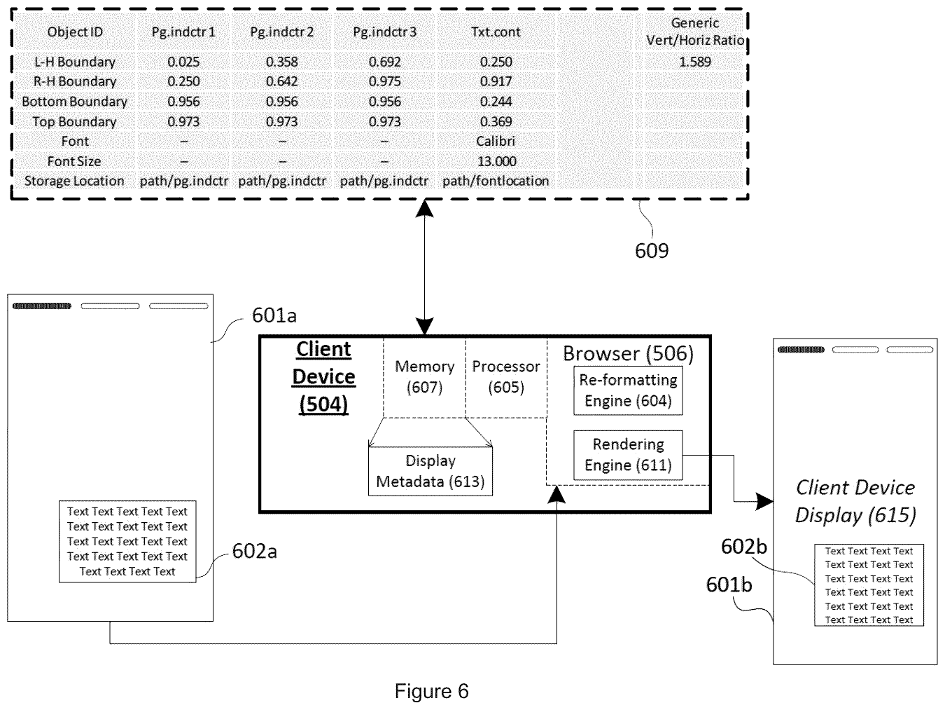

According to embodiments of the present invention, textual content may be re-sized based on an automatic determination of a text re-sizing factor by a re-formatting engine performing a format optimisation process (see FIG. 6). The text re-sizing factor may be determined by the re-formatting engine based on HTML, CSS and JavaScript code defining, for example, a MUEE, and additionally based on metadata indicating technical specifications of a client display device. The re-formatting engine may access a data structure comprising the coded variables and metadata on which the format optimisation process operates. Technical implementation of the novel display resource management technique is described later herein, with reference to FIGS. 5 and 6. However, the visual effect of the present invention at a display of a client device is now described with reference to FIG. 4.

FIG. 4 shows a base display screen 401a, which may represent an entire display region of a client display device or a display window occupying a display region on a client display device. A horizontal dimension 403 of the first (base) display screen 401a has a size A, and a vertical dimension 405 of the base display screen 401a has a size B. The base display screen 401a is shown to display a MUEE in base dimensions, i.e., dimensions in which the MUEE has been designed or which are optimal for the displayed MUEE.

The MUEE shown in display screen 401a comprises a text region 407a of a base size in each dimension 403, 405, and comprising text of a base font size, which may be defined in standard ‘pt’ units or explicitly in height or width in pixels. The size and position of the text region 407a on the base display 401a may be defined based on absolute values such as absolute coordinates and distances.

A first alternate display 401b shows the same MUEE rendered on a display device or in a window of a first alternate size, with a horizontal dimension of size A′ and a vertical dimension of size B′. The first alternate sizes define a first alternate aspect ratio. A text region 407b, corresponding to the text region 407a of the base display 401a, is re-sized in the first alternate display 401b proportionally to the change in size of the display screen relative to the base display 401a. That is, the text region 407b of the first alternate display 401b is horizontally re-sized based on fractional change in the horizontal dimension

$$( \frac{{A}^{′}}{A} ) ,$$

and is vertically re-sized based on a fractional change in the vertical dimension,

$$( \frac{{B}^{′}}{B} ) .$$

The text within the text region 407b is re-sized based on an output of the re-formatting engine. In some embodiments, the output may be calculated by taking the ratios

$$\frac{{A}^{′}}{A} and \frac{{B}^{′}}{B}$$

and performing a comparison operation to determine a smallest value of the two ratios. The smallest value may be used by the re-formatting engine as a re-sizing factor, applied to the base font size to generate a first alternate font size. In the example of FIG. 4, the ratio

$$\frac{{A}^{′}}{A} = 0.566$$

and the ratio

$$\frac{{B}^{′}}{B} = 0.791 .$$

The re-formatting engine may therefore determine that the ratio

$$\frac{{A}^{′}}{A}$$

should detine a scaling factor for font size in screen 401b, relative to the font size in base screen 401a. By way of example, the font size in screen 401a is 14 pt. The re-formatting engine may apply the scaling factor (or re-sizing factor) to determine a font size of 0.566×14=7.92 pt. The first alternate display screen 401b comprises text of font size 8 pt; it will be appreciated that the re-formatting engine may execute a rounding function to output an integer font size or to a given number of decimal places in the relevant units. In other examples, font size may be defined explicitly by height in pixels, in which case the format optimisation process may be further based on metadata indicating pixel density.

In another example shown in FIG. 4, a second alternate display 401c shows the same MUEE rendered on a display device or in a window of a second alternate size, with a horizontal dimension of size A″ and a vertical dimension of size B″. values A″ and B″ define a second alternate aspect ratio. A text region 407c, again corresponding to the text region 407a of the base screen 401a, is horizontally re-sized based on fractional change in the horizontal dimension relative to base screen 401a

$$( \frac{{A}^{″}}{A} ) ,$$

and is vertically re-sized based on a fractional change in the vertical dimension relative to base screen 401a,

$$( \frac{{B}^{″}}{B} ) .$$

Text within the text region 407c is re-sized according to a second output of the format

optimisation process, performed by the re-formatting engine. In the second example, the output is calculated by taking the ratios

$$\frac{{A}^{″}}{A} and \frac{{B}^{″}}{B}$$

and performing a comparison operation to determine a smallest of the two ratios. In some embodiments, the output may be calculated by taking the ratios

$$\frac{{A}^{″}}{A} and \frac{{B}^{″}}{B}$$

and performing a comparison operation to determine a smallest value of the two ratios. The smallest value may be used by the re-formatting engine as a re-sizing factor, applied to the base font size to generate a first alternate font size.

In the example of FIG. 4, the ratio

$$\frac{{A}^{″}}{A} = 1.508$$

and the ratio

$$\frac{{B}^{″}}{B} = 0.474 .$$

The re-formatting engine may therefore determine that the ratio

$$\frac{{B}^{″}}{B}$$

should define a scaling factor for font size in screen 401c, relative to the font size in base screen 401a. By way of example, the font size in screen 401a is 14 pt. The re-formatting engine may apply the scaling factor (or re-sizing factor) to determine a font size of 0.474×14=6.64 pt. The second alternate display screen 401b comprises text of font size 6.6 pt.

### MUEE Access Across a Network

FIG. 5 shows a highly schematic diagram of an exemplary computing environment in accordance with FIG. 2. FIG. 5 shows an embodiment in which a host system 502, comprising online MUEE content in a base format, is connected via a network 510 such as the internet to a plurality of client devices 504.

In the example of FIG. 5, three exemplary client devices 504a, 504b, 504c are shown, each comprising a respective display 512a, 512b, 512c, which each have different aspect ratios, different technical specifications such as pixel densities, and/or different absolute dimensions.

Each client device 504 further comprises a re-formatting engine 508 configured to operate the format optimisation process described herein. Each client device 504 further comprises a respective browser application 506. It will be appreciated that the specific browser applications on each respective client device may be a different browser application. However, it will also be appreciated that, generally, any browser may be capable of compiling MUEE content for display at the display 512 of a client device based on variables in HTML, CSS and JavaScript code, and further based on instructions issued by the re-format engine.

As described with reference to FIG. 2, the browser 506 of each client device may be configured to issue an HTTP or other suitable request across the network 510 to locate and retrieve online content stored at the host system 502.

On receipt of the requested online content at the client device 504, via an HTTP or message of another suitable format sent by the host system 502, the re-format engine may be configured to construct a data structure comprising data necessary to perform the format optimisation process described herein (see description of FIG. 6). The client device may then be configured to compile the accessed content according to instructions by the re-formatting engine to render the content at the display 512 of the client device.

### Data Management Techniques

Reference is made to FIG. 6, which shows a highly schematic diagram that illustrates exemplary data processing techniques which may be used to implement the invention described herein.

FIG. 6 shows a client device 504, the client device capable of accessing digital content such as a MUEE from a host system via a network, as described with reference to FIGS. 2 and 5.

The client device 504 is shown to comprise a browser 506, wherein the browser may be configured to request access to the exemplary MUEE comprising a base page 601a at a host system via a network, and to download an electronic message indicating the MUEE as described with reference to FIGS. 2 and 5.

The client device 504 is further shown to comprise a processor 605, which may be constituted by one or more processing unit, and a memory component 607. The memory component 607 may comprise one or more storage device capable of storing data that may be accessed and operated on by the processor, and may further comprise computer-readable instructions which when executed by the processor 605 cause may implement routines for accessing, processing, and rendering a MUEE or other content item.

As indicated previously herein, the browser 506 may be a local computer program, stored in the memory component 607. That is, the browser program 506 may comprise computer code that is accessible to the processor 605 for implementing functions that the browser 506 is enabled to provide.

The client device 506 of FIG. 6 further comprises a client display device 615, which may be configured to configured to render and display content in response to instructions from the processor 605.

FIG. 6 shows a base page 601a of an exemplary MUEE, which is shown within a first display or window of first dimensions, wherein the first dimensions indicate a first aspect ratio. The page 601a further comprises three page indicators (see description of FIG. 1), and an exemplary text region 602a comprising text of a first font size. Receipt of the page 601a at the browser 506 is represented in FIG. 6 by an arrow between the page 601a and the browser component 506.

Computer code, such as CSS defining visual aspects of the page 601a, may define absolute sizes and positions of content within the page 601a, e.g., in pixels, and may further indicate a frame of an absolute size (corresponding to the first dimensions), within which the content is defined. The client device 504, in particular a re-formatting engine of the browser 506 may be configured to generate a data structure 609, exemplified in FIG. 6, which may indicate the same page layout of page 601, but wherein the positions and sizes of content elements therein are defined as a fraction of the height and width of the frame for page 601a.

For example, data structure 609 comprises an entry for a left-hand boundary (L-H Boundary) of the text container 602a, listed as 0.250. This entry may indicate that a left-hand boundary of the text container 602a is located a quarter of the frame width from a left-hand extreme of the frame.

In other examples, rather than fractional entries in the data structure 609, arbitrary units representing, for example, 1% frame height and 1% frame width may be defined, and the data structure 609 may list values based on the arbitrary units. Note that such arbitrary units remain relative to the size of the frame, rather than absolute in distance or position within a frame of absolute dimensions.

Similarly, the data structure 609 comprises data indicating a font size of text within the text container 602a. It will be appreciated that text itself should not be stretched in one dimension, independently of the other. Text on a page 601 may be provided in standard font sizes, wherein the ratio of a character's height to its width should remain constant across all font sizes. That is, only one degree of freedom exists in font size because defining a height infers a width. Therefore, the font size value “13” shown in data structure 609 may indicate either a relative height or a relative width (e.g., in arbitrary relative units).

It will be appreciated that the generation of the data structure 609 may be done based on instructions provided by the browser 506 and implemented by the one or more processor 605. The browser 506 may comprise a dedicated software component referred to herein as a re-formatting engine 604, which may be a software component configured to extract code in the accessed content and construct a data structure such as structure 609. The data structure 609 may be stored in memory 607 and where it is accessible to the processor 605.

Note that the data structure 609 may further comprise other relevant data, such as an indication of a generic aspect ratio of the accessed MUEE in its first (base) dimensions, or path to memory locations at which further data, such as images or sprites for rendering on the display, may be accessed by the browser.

The browser 506 of the client device 504 is further shown to comprise a rendering engine 611. The rendering engine may be configured to control the client display device 615 to display content. In some examples, the rendering engine 611 may be considered to form part of the browser 506.

The rendering engine 611 may be configured to access display metadata 613 indicating absolute dimensions and technical details (such as pixel density) of the client display device 615, which may differ to those of the base page 601a. The display metadata 613 may be stored in memory 607 of the client device. The browser 506 may use the display metadata 613 in conjunction with the data structure 609 accessed from memory 607, to generate computer-readable instructions which, when executed by the processor 605, cause the client display device 615 to display a modified page instance 601b. The modified page instance 601b may be proportionally identical in layout with respect to the base page 601a, meaning that fractional sizes and locations relative to respective display dimensions may be constant in pages 601a and 601b.

The modified page instance 601b may be constructed based on the techniques described herein, such as with reference to FIGS. 4 and 5. The display metadata 613 may define absolute pixel dimensions of the client display device 615 and the browser may cause values in the table 609 to operate as scaling factors on the absolute values indicated in the metadata 613. That is, combining the relative dimensions of data structure 609 by the absolute dimensions of the client display device 615 indicated in the metadata 613 provides absolute dimensions of content for rendering on the modified page instance 601b.

The browser 506 may be configured, via one or more of the re-formatting engine 604 and the rendering engine 611, to retrieve data defining the base page 601a and the display metadata 613 for the client display device to perform a textual re-formatting operation according to the description of FIG. 4. This re-formatting operation enables textual content to be re-formatted with global consistency and without overflowing text regions, even if aspect ratios between a base 601a and modified 601b pages vary. “Global consistency”, mentioned above, may imply that all text in a MUEE displayed on a display region of particular dimensions may be changed in size by a same scaling factor, ensuring relative consistency in font size of different instances of text.

It will be appreciated that, whilst specific embodiments of the invention have been described, these are not exhaustive. The scope of the invention is not defined by the described embodiments but only by the appendant claims.

1. An apparatus for re-formatting text content of a non-scrollable multi-screen web resource comprising:
one or more processors; and
a non-transitory computer readable medium storing a plurality of instructions, which when executed, cause the one or more processors to:
receive, at a browser, a message indicating the web resource, the web resource
comprising:
a frame defining a display boundary and having first measurements in
two dimensions; and
text content of a predefined font size;
identify, by the one or more processors, in the two dimensions, second measurements of a display window of a display;
determine, by the one or more processors, a first ratio indicating the size of the second measurements of the display window in a first dimension of the two dimensions, relative to the first measurements of the frame in the first dimension;
determine, by the one or more processors, a second ratio indicating the size of the second measurements of the display window in a second dimension of the two dimensions, relative to the first measurement of the frame in the second dimension;
re-scale, by the one or more processors, the frame to generate a modified frame, the modified frame having the same second measurements as the display window;
perform, by the one or more processors, a comparison operation to determine a smallest ratio of the first and second ratios, and re-scale the predefined font size by a factor of the smallest ratio to determine a modified font size; and
cause, by the one or more processors, the modified frame of the web resource comprising text content of the modified font size to be displayed within the display window of the display.

2. The apparatus of claim 1, wherein the frame further comprises a text region of a predefined size within the frame, the text region supporting the text content, and wherein the re-formatting engine is further configured to:
re-scale the text region in the first and second dimensions by respective scaling factors equal to the first and second ratios, to generate a modified text region; and
cause display of the text content of the modified font size within the modified text region.

3. The apparatus of claim 1, wherein the display occupies an entire display region of the display.

4. The apparatus of claim 1, wherein the display window occupies a subset of a display region of the display.

5. The apparatus of claim 1, wherein the display comprises a plurality of display windows and wherein the modified frame and text content of the modified font size are displayed in one of the plurality of display windows.

6. The apparatus of claim 1 comprising a computer memory in which the second measurements of the display window are stored as metadata, wherein the second measurements in the computer memory are accessible to the re-formatting engine for determining the first and second ratios.

7. The apparatus of claim 1, wherein the re-formatting engine is comprised within the browser.

8. The apparatus of claim 2, wherein the text region has a predefined position within the frame and wherein the re-formatting engine is further configured to:
identify a reference point associated with the text region;
calculate a relative position of the reference point in the first and second dimensions, relative to the first measurements of the frame;
determine an absolute position of the reference point within the modified frame, at which the relative position of the reference point relative to the second measurements of the modified frame is the same as the relative position of the reference point relative to the first measurements of the frame; and
cause display of the modified text region such that the reference point associated with the modified text region is located at the determined absolute position.

9. The apparatus of claim 8, wherein the reference point is identified at a centre of the associated text region.

10. The apparatus of claim 8, wherein the reference point is identified at a corner of the associated text region.

11. The apparatus of claim 2, wherein a horizontal alignment of the text content of the web resource within the text region is defined as one of: left-aligned, right-aligned, centre aligned, or justified, and wherein a vertical alignment of the text content of the web resource within the text region is defined as one of: top-aligned, middle-aligned, or bottom-aligned.

12. The apparatus of claim 1, wherein the web resource is of a multi-screen user engagement experience format.

13. A computer program product, comprising a non-transitory computer-readable medium having computer-readable program code embodied therein to be executed by one or more processors, the program code including instructions to:
receive, at a browser of a computer device, a message indicating a web resource, the web resource comprising:
a frame defining a display boundary and having first measurements in two dimensions; and
text content of a predefined font size; identify, in the two dimensions, second measurements of a display window of a display;
determine a first ratio indicating the size of the second measurements of the display window in a first dimension of the two dimensions, relative to the first measurements of the frame in the first dimension;
determine a second ratio indicating the size of the second measurements of the display window in a second dimension of the two dimensions, relative to the first measurement of the frame in the second dimension;
re-scale the frame to generate a modified frame, the modified frame having the same second measurements as the display window;
perform a comparison operation to determine a smallest ratio of the first and second ratios, and re-scale the predefined font size by a factor of the smallest ratio to determine a modified font size; and
cause the modified frame of the web resource comprising text content of the modified font size to be displayed within the display window of the display.

14. A computer implemented method of re-formatting text content of a non-scrollable multi-screen web resource, the method comprising:
receiving, at a browser of a computer device, a message indicating a web resource, the web resource comprising:
a frame defining a display boundary and having first measurements in two dimensions; and
text content of a predefined font size;
identifying, in the two dimensions, second measurements of a display window of a display;
determining a first ratio indicating the size of the second measurements of the display window in a first dimension of the two dimensions, relative to the first measurements of the frame in the first dimension;
determining a second ratio indicating the size of the second measurements of the display window in a second dimension of the two dimensions, relative to the first measurement of the frame in the second dimension;
re-scaling the frame to generate a modified frame, the modified frame having the same second measurements as the display window;
performing a comparison operation to determine a smallest ratio of the first and second ratios, and re-scaling the predefined font size by a factor of the smallest ratio to determine a modified font size; and
causing the modified frame of the web resource comprising text content of the modified font size to be displayed within the display window of the display.
